(19) United States
(12) Patent Application Publication
(10) Pub. No.: US 2024/0046224 A1
(43) Pub. Date: Feb. 8, 2024

(54) System and Method for Management of Remote Assets with Data Aggregation

(71) Applicant: TyCorra Investments Inc., Kitchener (CA)

(72) Inventors: Brent LARSON, Kitchener (CA); Susan Denise MOTKALUK, Kitchener (CA); Matthew John WALDRON, Kitchener (CA)

(21) Appl. No.: 18/450,595

(22) Filed: Aug. 16, 2023

Related U.S. Application Data
(63) Continuation of application No. PCT/CA2022/050224, filed on Feb. 16, 2022.
(60) Provisional application No. 63/149,899, filed on Feb. 16, 2021.

(51) Int. Cl. G06Q 10/20; G07C 5/00; G07C 5/08

(52) U.S. Cl. CPC G06Q 10/20; G07C 5/008; G07C 5/006; G07C 5/0808

(57) ABSTRACT

A system and method for managing remote assets with data aggregation. The system including: a server running software to manage data and communications; a database accessible by the server; a client application provided to one or more clients, in communication with the server; wherein the server is configured to control a method that includes: receive communications from the remote asset and receive communications from the client application; analyze the received communications for data related to the remote asset; determine if the data indicates an issue in relation to the remote asset; if so: determine a prescribed action based on the issue and the data; automatically determine resources for the prescribed action; and send communications to at least one of the remote asset and the client application with the prescribed action and determined resources, if not, continue to receive and analyze the received communications.

### RELATED APPLICATIONS

This application is a continuation of PCT Application No. PCT/CA2022/050224, filed Feb. 16, 2022 which claims priority to U.S. Patent Application No. 63/149,899, filed Feb. 16, 2021, which are hereby incorporated herein by reference.

### FIELD

The present disclosure relates generally to a system and method for managing remote assets and data aggregation and, more particularly, to a system and a method for managing remote, fixed commercial, and consumer assets and data aggregation for multiple asset owners and operators.

### BACKGROUND

In conventional asset management systems, an asset may be tracked and data from the asset monitored, for example, GPS position, sensor information, or the like. In some cases, the asset management system may include tracking of at least some maintenance or repair of the asset involved.

As an example, management and maintenance of commercial vehicles, including vehicles such as trucks, trailers and the like, can involve management systems and coordination among multiple service providers. The owners/operators (private or for-hire fleets) of a group of commercial vehicles, generally called “fleets”, often operate throughout a large geographic area, regionally, nationally, or internationally, on public and private roads, properties, and highways, 24 hours of the day, 7 days of the week. Fleets may be made up of, for example, commercial trucks, trailers, shunt trucks, fork lifts, refrigeration units, passenger vehicles, and related equipment. Fleets are generally required to be registered and to maintain the operating condition of their assets to meet regulatory standards, including scheduled inspections, annual safety certification, performing manufacturer recalls, ensuring repairs to assets are completed in a manner that meets industry maintenance and safety standards, as well as emissions and regulatory standards at all times. In addition to regulatory requirements, it is helpful if a fleet can be managed to include preventative maintenance to prevent future problems and the like.

Most conventional fleets struggle to measure and achieve these objectives due to issues involving the complexity of the systems, number of users, difficulty in tracking, use of manual processes and records, and other issues. Issues with fleet maintenance can result in safety incidents and accidents, increased liability, underutilized and oversized fleets, increased maintenance costs, incomplete data for reporting and analytics, unreliable forecasts and budgets, uncertainty about when to dispose of assets, uncertainty about replacement asset specification and make/model, and overall reduction in profitability for the fleet owner and/or operator.

As such, there is a need for an improved system and method for managing remote assets that overcomes at least some of the issues with conventional systems and methods.

### SUMMARY

According to one aspect herein, there is provided a system and a method for managing remote assets with data aggregation for multiple asset owners and operators. The system and method are intended to include one or more of: integrating the maintenance supply chain, managing remote assets, data and communication integration amongst fleets, service organizations or venders, product/part vendors, manufacturers, and suppliers, including aggregation of data, preferably at the time and point of maintenance across a fleet's network. This integration is intended to facilitate analytics and benchmarking, regulatory compliance, support cost management, cost reduction, warranty detection and recovery, cost reduction initiatives, reporting and analytics, and analysis to optimize equipment life cycle cost of ownership, particularly in relation to the operation of commercial truck, trailer, and other equipment and assets requiring maintenance across a range of industries.

According to an aspect herein, there is provided a system for managing remote assets, the system including: a server running software to manage data and communications; a database accessible by the server; a client application provided to one or more clients, in communication with the server; wherein the server is configured to: receive communications from the remote asset and receive communications from the client application; analyze the received communications for data related to the remote asset; determine if the data indicates an issue in relation to the remote asset; if so: determine a prescribed action based on the issue and the data; automatically determine resources for the prescribed action; and send communications to at least one of the remote asset and the client application with the prescribed action and determined resources, if not, continue to receive and analyze the received communications.

In some cases, the analyze the received communications for data related to the remote asset may include combining communications from the remote asset with communications from the client application and database entries.

In some cases, the determine if the data indicates an issue may include comparing the data to one or more thresholds. In this and other cases, the issue may be selected from the group of wheel end temperature overheating, loss of tire pressure, battery mismatch, and battery charge out of range.

In some cases, the determine a prescribed action may include matching the data and issue with a prescribed action based on at least one of historical data and a predetermined table of prescribed actions.

In some cases, the automatically determine resources may include: determining a location of the remote asset; determining resources that has a location geographically proximate to the remote asset; contacting the resources to determine availability and select one or more resources based on location and availability; and confirm the one or more selected resources to provide the prescribed action.

In some cases, the prescribed action may include one or more of determine a service vendor in the vicinity of the remote asset, notify a driver to stop the remote asset for repair, notify a driver to go to a determined service vendor for repair, flag a remote asset for preventative maintenance at the next available opportunity.

According to another aspect herein, there is provided a method for managing remote assets, the method including computer-executable instructions that when performed on a processor cause the processor to: receive communications from the remote assets and receive communications from a client application; analyze the received communications for data related to each remote asset; determine if the data indicates an issue in relation to the remote asset; if so: determine a prescribed action based on the issue and the data; automatically determine resources for the prescribed action; and send communications to at least one of the remote asset and the client application with the prescribed action and determined resources, if not, continue to receive and analyze the received communications.

In some cases, the analyze the received communications for data related to the remote asset may include combining communications from the remote asset with communications from the client application and database entries.

In some cases, the determine if the data indicates an issue may include comparing the data to one or more thresholds.

In some cases, the issue may be selected from the group of wheel end temperature overheating, loss of tire pressure, battery mismatch, and battery charge out of range.

In some cases, the determine a prescribed action may include matching the data and issue with a prescribed action based on at least one of historical data and a predetermined table of prescribed actions.

In some cases, the automatically determine resources may include: determining a location of the remote asset; determining resources that has a location geographically proximate to the remote asset; contacting the resources to determine availability and select one or more resources based on location and availability; and confirm the one or more selected resources to provide the prescribed action.

In some cases, the prescribed action may include one or more of determine a service vendor in the vicinity of the remote asset, notify the determined service vendor to attend at the remote asset location, notify a user to stop the remote asset for repair, notify a user of the remote asset to go to a determined service vendor for repair, flag a remote asset for preventative maintenance at the next available opportunity.

Other aspects and features of the present disclosure will become apparent to those ordinarily skilled in the art upon review of the following description of specific embodiments in conjunction with the accompanying figures.

### BRIEF DESCRIPTION OF THE DRAWINGS

Embodiments of the present disclosure will now be described, by way of example only, with reference to the attached Figures.

FIGS. 1A and 1B show a schematic of an embodiment of a system for managing remote assets with data aggregation;

FIGS. 2A and 2B show a schematic of another embodiment of a system for managing remote assets with data aggregation;

FIG. 3 is a flowchart showing an example of the handling of a task within embodiment of the system and method herein;

FIG. 4 shows a schematic of an example of handling determination of a resource for a typical task within embodiments of the system and method herein;

FIG. 5A Driver Roll Call—is a schematic illustrating an embodiment of a process performed by an application and end users for a driver roll call use case;

FIG. 5B Information Distribution—is a schematic illustrating an embodiment of a process performed by the application, databases and end users for an information distribution use case;

FIG. 5C Historical documentation (Photo Capture)—is a schematic illustrating an embodiment of a process performed by the application, databases and end users for a historical documentation and pre/post trip inspection (photo capture) use case;

FIG. 5D On-Road Breakdown Repair request—is a schematic illustrating an embodiment of a process performed by the application, databases and end users for an on-road breakdown use case;

FIG. 5E Service Request—is a schematic illustrating an embodiment of a process performed by the application, databases and end users for an urgent service request use case;

FIGS. 6A-6D show a flowchart illustrating an example, of the handling of data and analysis in an embodiment of the system and method for managing remote assets;

FIG. 7 is a flowchart illustrating an example of a determination of a prescriptive action from the flowchart of FIG. 6;

FIG. 8 is a flowchart illustrating another example of a determination of a prescriptive action; and

FIG. 9 is a flowchart illustrating another example of a determination of a prescriptive action.

### DETAILED DESCRIPTION

Generally, the present disclosure provides an improved system and method for managing remote assets and data aggregation which incorporates elements such as remote repair management (including service technician dispatch); warranty administration; work order administration; purchase order processing; and communication among asset owners/operators, service organizations, parts suppliers, warranty providers, and OEMs. The system and method also provide for data aggregation from the disparate parties to maintain a record of activity with regard to each asset being managed.

As noted above, fleets may be made up of, for example, commercial trucks, trailers, shunt trucks, fork lifts, refrigeration units, passenger vehicles, and related equipment. While the focus of this document is on fleets of commercial trucks and trailers, similar concepts can be applied to other types of remote assets.

The objectives of fleet management can include aspects such as increasing fleet uptime, regulatory compliance, preventive maintenance and inspections, cost management, cost reduction, fleet safety, fleet lifecycle cost and replacement, standardization of repairs and maintenance, reporting, analytics, and benchmarking. Most fleets struggle to achieve or even measure these objectives. An objective of embodiments of the systems and methods herein is to provide an integrated system and data that can provide timely, accurate maintenance data that will facilitate reporting, budgeting, forecasting, and managing of maintenance costs, optimize uptime, update fleet safety compliance, and promote standardization of maintenance practices in their own facilities and third party maintenance and repair organizations (MROs).

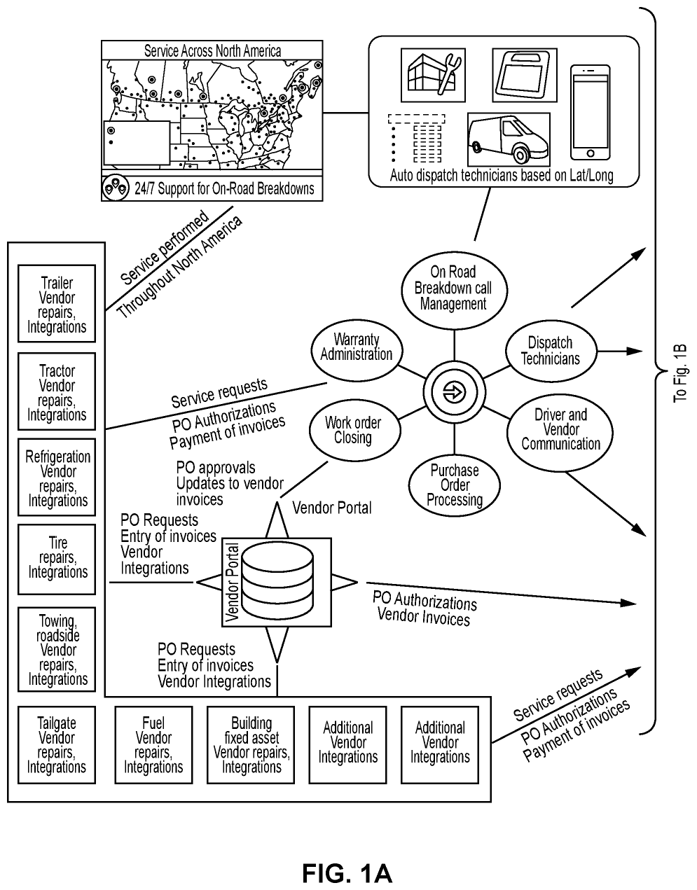

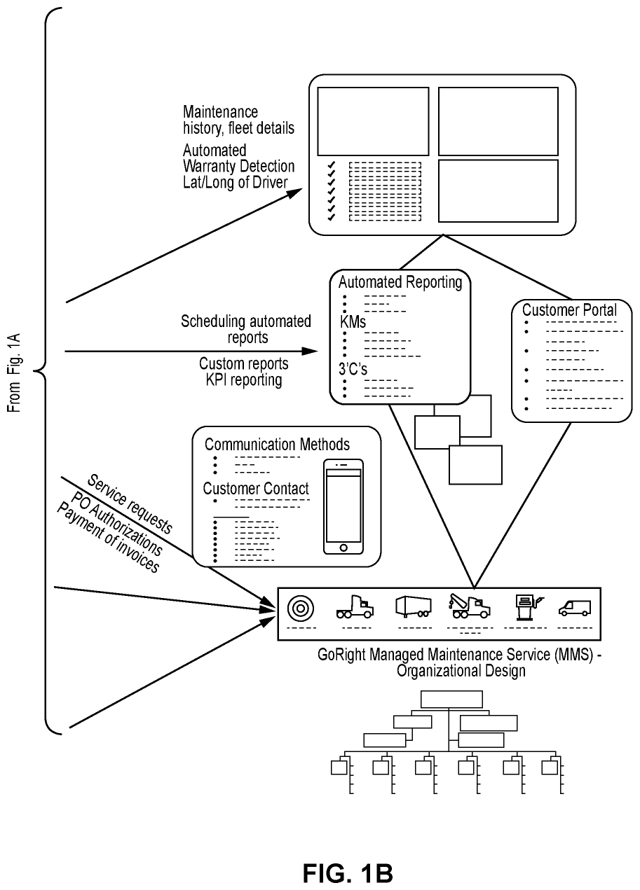

FIG. 1 is a schematic drawing of an embodiment of a system for managing remote assets. As shown, the system provides a hub that provides various types of functionality and integrates data from a variety of sources. The system includes various modules to provide access to drivers/controllers of the assets, owners of the assets, service providers, parts/warranty providers, OEMs, an IMSC network, and the like. In some cases, the modules may include a vendor portal, a warranty portal, a communication module, and the like. Other modules that may be included in the system include, for example, a sales order module, a business information (ERP/NAV) module, a mobile application/hub, a vendor portal and one or more vendor/internal modules. The system will also include at least one processor and at least one database. In some cases, the system may be distributed and make use of a plurality of processors and databases.

In this embodiment, the modules can provide content to various integration tools, including, for example, a NAV to NAV converter tool, an XML tool, a database tool, and the like. The integrated content is then processed by an integrated system module and stored in one or more databases based on the integrated content type. The database or databases may be any of various types of known database, including, for example, SQL databases and the like. The databases can then be accessed by one or more reporting tools, such as, for example, business information tools or SQL report generators or the like. In some cases, the reporting tools may access the databases through a gateway or the like to allow connection to multiple data sources or databases. The reporting tools can allow for various types of reporting, including, for example, self serve portals, dashboards, email reports, access by external service provider/customer systems, or the like.

Generally speaking, embodiments of the system and method herein are intended to provide for integrating the maintenance supply chain throughout a region in which a fleet, customer, or consumer operates, locally, regionally, nationally, or internationally. Further, at least some embodiments provide for management of condition and uptime of assets or groups of assets, standardizes maintenance and repairs to assets, streamlines communications between the owners and operators of the assets (fleets/customers/consumers) and the maintenance and repair organizations (MROs) and vendors, capturing and aggregating maintenance and repair data for each transaction wherever and whenever maintenance is performed, then performing automated and custom analytics on the maintenance data, creating and sending electronic reports or providing portal access for detailed reporting and analytics of the assets to the owners/operators of the assets.

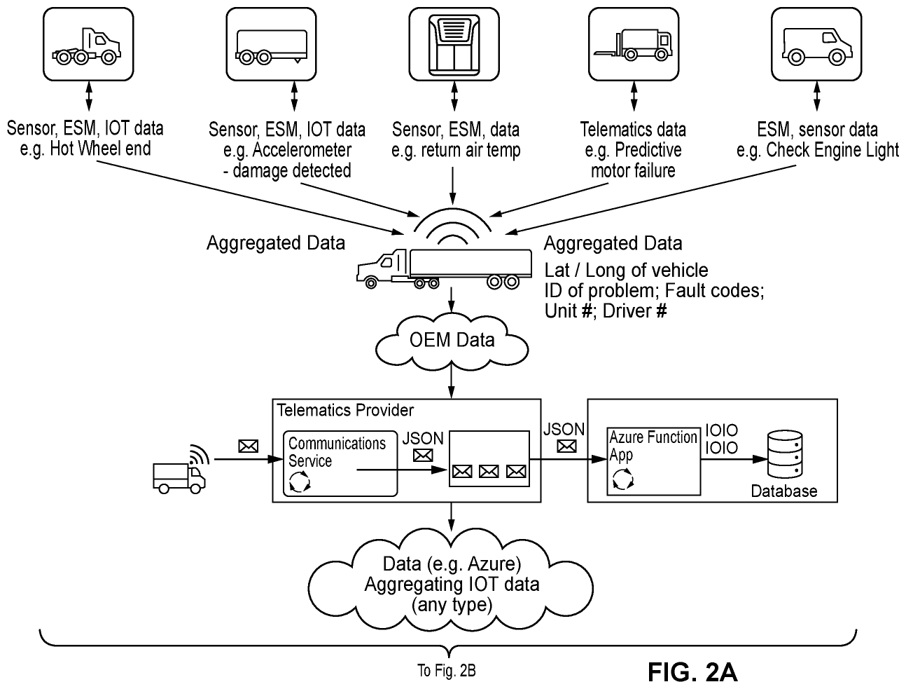

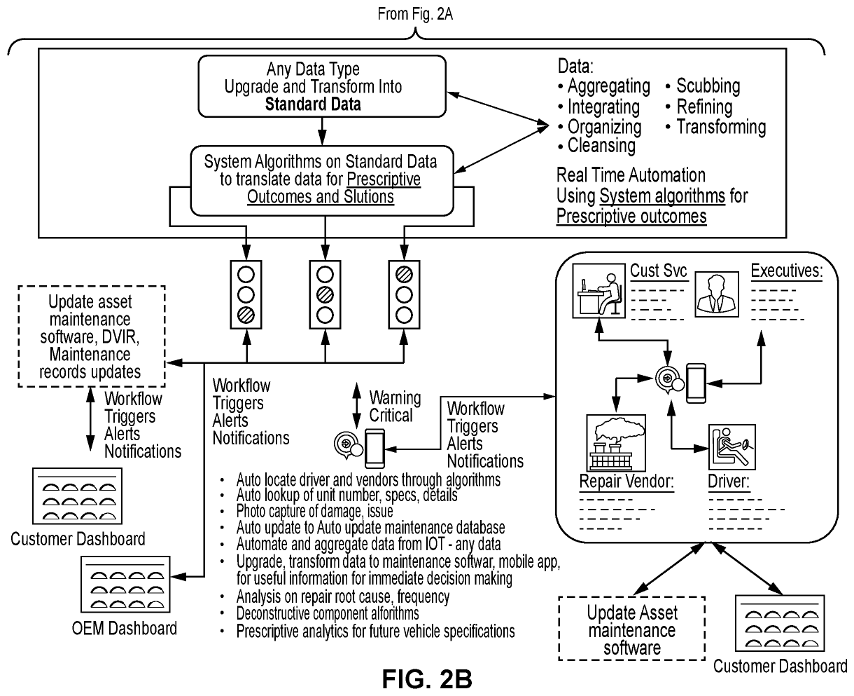

FIGS. 2A and 2B is a schematic view of another embodiment of a system for managing remote assets with data aggregation. As illustrated in FIG. 2, this embodiment is intended to provide a system and method for managing assets, data aggregation, and communications and can include a technology and standard work platform, standardized data capture, integrations, reporting, including automated alerts, reports and custom data and insights portals for fleets, customers, consumers, OEMs, vendors, MROs and the like.

Embodiments of the system and method are configured to coordinate and integrate services from maintenance and repair providers/operators (MROs), vendors of equipment, parts or the like, and fleet owned and/operated transportation and other assets leveraging communication software and services, to coordinate repairs and maintenance between the various participants in the overall process. Data from each repair and maintenance transaction is captured electronically using, for example, mobile tablet computers connected to the network, input by an MRO/franchisee or vendors and IMROs through a web based portal or the like, direct integrations with MROs/franchisees and vendors, or by electronic or paper copy submitted by an MRO/franchisee/IMRO to the fleet, customer, or consumer to manually input the transaction. Data is captured by the system from various sources, including all maintenance transactions, to provide as complete, timely, and accurate data about the remote assets as possible for analytics and benchmarking.

The repair and maintenance data is aggregated in a software as a service (SaaS) solution, sometimes called an enterprise platform (EP), which is included in embodiments of the system and method herein. The SaaS is intended to provide real time, automated reporting and analytics, including value added services, to optimize asset utilization and performance, including electronic communications to coordinate maintenance and repairs. This coordination can include standardization of the repair methods and parts as defined by, for example, the fleet, and used in repairs. The SaaS can provide functionality such as automated warranty detection, automated chronic repair detection and automated notifications and alerts sent directly to the appropriate party through email, phone, or portal notifications at an appropriate timing. Data relating to each repair can be automatically organized in an appropriate format from repair and maintenance transactions and aggregated. The communications technology can also facilitate quote requests for repairs and maintenance, purchase order authorizations and facilitate vendor payments to vendors for repairs and maintenance services. Communications for repair requests (emergency, in yard/facility, scheduled, unscheduled, on road breakdowns, etc.), can be captured electronically into the EP, linked to the asset maintenance history record.

Asset service requests can be made through an app or online portal to request maintenance on any assets, which can be routed to an appropriate vendor through the EP. Service request metrics can be measured and tracked at each stage of the service request, and the EP can provide performance reports based on Customer. This can allow the Customer to measure response times of MROs in the network and measure and optimize uptime of the assets. The MROs receive opportunities to perform maintenance for contracted Customers in the EP, with efficient and integrated communications within the system.

Embodiments of the system and method can provide detailed maintenance management of a customer's remote assets, including but not limited to transportation and distribution industries and other assets. The system includes an enterprise platform that collects individual repair and maintenance transactions for each asset and a fleet or group of assets from repair providers (MROs) and aggregates the data from each transaction. The EP collects and converts data received into information to analyze life cycle maintenance costs and uptime and coordinates maintenance activities.

The EP provider (sometimes call the EPP) may also provide additional fee based mechanical services and communication tools and services to repair and maintain customer assets or group of assets, which may include transportation trucks, trailers, refrigeration units, lift gates, heater units, fork lift trucks, shunt trucks, accessories for each asset, amongst other assets.

The EPP can provide planning and scheduling, coordinating and managing, and at times performing maintenance services to provide mechanical inspections to confirm regulatory compliance for remote assets, periodic preventive maintenance mechanical inspections, scheduled and unscheduled maintenance, and emergency and on road breakdown maintenance,

The EPP, upon entering into a contract with a Customer, loads the customer's asset details into the EP, to facilitate asset and fleet management functions and contracted services for the customer. Services can include all aspects of asset and fleet management and maintenance, including but not limited to scheduling of preventive maintenance inspections, OEM recommended inspections, regulatory required inspections, coordinating and/or performing scheduled and unscheduled maintenance, recalls and campaigns, emergency or urgent on site, off site, or road side maintenance. The EPP performs these services, and coordinates these services with MROs through its EP and related services, with centralized management, coordination, data collection and storage, and reporting and analytics for the customer.

The MRO can capture data from most or all repair and maintenance transactions directly through its employee or broker technicians through hand held or other computing devices, online apps, web-based portals, or direct entry by the MRO into the EP integrated online hardware and software tools, connected to a central database. In some embodiments, the MRO uses standard data and repair methods developed and deployed by the EPP to advise maintenance and repair organizations (MROs) how to safely and properly complete each repair using its standard work methods, standard jobs, standard parts, warranty detection and recovery methods, and other standard work methods. The EP provides online tools to communicate with the MRO employees and agents to request purchase orders, purchase order approvals to proceed with repairs, invoicing and payments, and the standards to follow in completing repairs, utilizing the central database. The EPP may own/operate its own facilities and mobile technicians to complete repairs, leveraging direct access to its central database through connected technology tools. The MROs can communicate through website interfaces, apps provided on phones, or the like. The EPP or EP arranges for scheduled repairs and maintenance, unscheduled repairs and maintenance, emergency repairs, and inspections and preventive maintenance and annual inspections through apps, online tools, scheduling software, and automated reporting.

The EP can standardize the methods and parts used in a repair through standard work definition and documents including documented repair methods and standard parts to be used at time of repair (either industry recommended or preferred or customer preferred methods and parts) to provide for safety, quality, and performance of each replacement part. The standardization of repair methods and parts optimizes asset uptime and reduces chronic repairs due to wear and tear and damage between preventive maintenance inspections, as well as improves safety to the public and infrastructure through reduced accidents, injuries, fatalities, and unscheduled breakdown incidents.

Through standardization, performing preventive maintenance, central database integrations, and integrated communication tools with stakeholders, the EP optimizes asset uptime and reduces the number of assets required to perform tasks, reducing the cost to the fleet or asset owners/operators to operate a fleet or group of assets, including reducing the number of spare or idle assets. Optimizing uptime of assets allows owners/operators of assets to employ fewer employees and staff to manage fewer incidents and assets. Integrating communications through online apps reduces communications, optimizing staffing levels and improving response time to scheduled, unscheduled, and emergency repairs and maintenance.

The EPP generally develops a network of approved MROs (“affiliated MROs”) and Vendors with which it coordinates and collects data from the preventive maintenance and inspections, scheduled and unscheduled maintenance, and sensor and asset data. To be classified as an affiliated MRO or Vendor for the EP, the MRO or Vendor agree to support industry standard repair methods and conventions, integration protocols, agree to meet the repair standards set out by the EPP. These standards can be set out in an MRO Operating Manual (MRO-OM).

The MRO-OM can include standard jobs, standard repair times, mutually agreed-to labour rates per hour or for a standard job, parts mark up pricing, warranty identification, warranty parts retention periods, warranty adjudication procedures, purchase order request and approval procedures, as well as invoicing and payment procedures and terms, all of which can be adjusted periodically by mutual agreement. It can also include key performance indicators (KPIs) such as throughput time and quantity of repairs, repair completion time, quote response time, on road breakdown response time, and other metrics as developed from time to time by the EPP, technician minimum qualifications, including onboarding training procedures, technician certification requirements, ongoing recertification and training, as well as MRO facility tooling and equipment requirements and certifications, maintaining appropriate insurance, minimum equipment and capabilities to perform the contracted work from the EPP, and to the EPP standards.

These standardized parts and repair methods can be organized into standard jobs which are codified and made available through the electronic/onoi-line tools and documents to repair technicians and affiliated MROs. In some cases, warranty can be detected in real time by the EP, or through the MRO vendor portal, whereupon the technician can be automatically notified to tag and store the part for warranty submission, and the owner/operator of the asset is notified automatically of pending warranty on a repair for warranty adjudication.

Embodiments herein are intended to allow for standardization of labour times to complete repairs, parts and labor pricing for customer maintenance transactions through the MRO network, eliminating, job stacking, over billing, improves repair methods to industry standards, improves standard parts compliance, improves asset uptime, improves asset utilization, improves warranty detection and recovery, improves chronic repair detection and resolution, improves safety of asset in operation, reduces customer fleet and asset liability, optimizes asset and fleet uptime and fleet size, improves data capture, reporting and analytics, and reduces staff resources that customer needs to employ to manage its asset maintenance.

Embodiments herein are also intended to provide at least some of: customers and MROs timely data, knowledge, communications, and integrations to provide for safe operation of assets on and off public and private roads, improve public safety through reduction or elimination of injury and/or deaths to the public, reduce damage to buildings and infrastructure, reduce associated liability, incidental, and insurance costs, improve Customer asset and fleet productivity, efficiency, uptime, utilization, and reduce the number of assets and resources required to manage asset operational performance, including movement of goods and services, lowering lifecycle asset TCO for the Customer.

The system (and EP) may include asset maintenance software and database to provide robust asset and fleet maintenance management for the EPP. As an example, the database may use an appropriate accessible format, be web based, and be customized to provide access through levels of security for a parent company to provide a holistic view, or restricted or reduced access to certain personnel as required. System generated and automated reports can be created from the EP database, such as asset and fleet reports, analytics, benchmarking, notifications, and alerts.

As illustrated in FIGS. 2A and 2B, the EP gathers and aggregates data from various transactions and sources, converts the associated data into a standardized format, processes the data to perform analysis, and stores the data for historical reference and analysis. The EP can create automated real time notifications, alerts, reports, and analytics for the customers. The notifications can be prioritized and may include a prescriptive action that the EP will take to resolve any issues.

The EP can collect real time repair and maintenance data from its network of MROs through the EP's communications and software tools. The repair and maintenance data collected can include labour and parts data which is converted into standard codification to standardize the repair and maintenance data for processing, analytics, reporting, and benchmarking. The captured and aggregated data for repairs and maintenance can be summarized into various compliance, cost management, cost reduction, budgeting, forecasting, benchmarking, other reports, as well as customizable reports, providing real time reporting and analytics for the stakeholders.

Aggregation of transactional data from repair and maintenance transactions of the assets can provide for analysis of performance of parts, assets, and groups to allow for real time reporting and feedback to original parts, component, and asset/equipment manufacturers (“OEMs”) about the performance of their products when in use. Product performance reports may be manually created or automated and posted electronically in portals or emailed automatically, accessible only to the OEM. The OEM may use the data and information from these reports to further enhance, improve, and innovate their products, as well as expedite research and development and commercialization, sales and marketing or other processes to support development of their products for the market. In some cases, the reports may be segmented regionally, by asset application, or other segregation methods. Predictive failure reports can also be generated using algorithms, sensors, and electronic communications of pending part failures are automatically electronically sent to OEMs for accident, incident, and downtime prevention, corrective action, and analytics.

In the EP, OEM extended and component warranty agreements can be assigned to the fleet/customer asset and parts records in the EP. Should an MRO or vendor replace a component or perform labour to an asset with a warranty agreement still in force at the time of the repair, the EP can automatically detect warranty, and an automated warranty detection alert, notification, and report can be generated. In some cases, the EP may commence warranty adjudication with the MROs and Vendors on behalf of the fleet/customer, updating progress through automated warranty recovery reporting. The EP is intended to enable automated warranty claim creation, tracking, and management of the warranty claim.

In the EP, repair and maintenance transactions can be captured for each component or repair, by part number, and including part by location on an asset. If a repair is performed on a part within a predefined period (30 days or less, or other period of time as established by part number as per SLA), an automated notification and chronic repair detection report can be generated. The EP may proceed to address the chronic repair issue with the MRO, to conclude root cause/corrective action to avoid future chronic repairs to the same component.

The EP may provide asset and maintenance reporting and analytics, based on aggregated data. For example, reporting may include one or more of asset regulatory compliance and inspection status reports, cost management reports, cost reduction progress and initiatives reports, as well as budgeting, forecasting, and analytical reports to analyze asset and fleet costs. Reports may also include asset and fleet dashboards that summarize and present key information that owners/operators of a Fleet or assets need to know. Some reports can include ‘drill down’ data capabilities. Automated reporting of performance data and criteria is intended to allow owners/operators of assets to measure KPIs such as asset performance, uptime, cost, including part level, groups of assets, including by region within a company. Automated reporting may also include various reports relating to status and completion of asset regulatory compliance and inspections, cost reports, campaigns and recalls, analytics to support cost reduction initiatives, budgeting and forecasting, geolocation and tracking, asset details, historical data and analytics, as well as custom reports.

Budgeting and forecasting can be made available through the capture of repair and maintenance data aggregation on a transaction-by-transaction basis, tracking date and time or transactions, and utilizing algorithms for predicting future costs and providing budgets for future periods to the owner of the assets.

The EP can provide analysis and recommendations on the ideal timing of asset disposal and replacement. Leveraging real time, maintenance data from the data aggregation, fleets/customers can review complete maintenance history to base decisions on ideal replacement timing. The EP can also combine life-to-date depreciation with the accumulated maintenance expense, along with key metrics such as fuel consumption and environmental compliance and CO2 impact, with emerging and new replacement technologies, to recommend to fleets/customers the costs/benefits of asset replacement. The EP may also maintain or obtain wholesale values of assets, along with replacement costs, to provide a life cycle analysis of disposal costs with replacement. This life cycle replacement analysis can be presented as a report for sound decision making.

Data aggregation across multiple customers may be sorted by application, region, timeframe, metering, usage and the like. The aggregated data can be analyzed and benchmarked against comparable products for product performance evaluation. The aggregated data may have confidential data removed, unpacked and sorted, so that it can be licensed to OEMs and OEs supporting data analysis on product performance, product commercialization, product development, invention of new products, and additional use data to confirm total cost of ownership and sales and marketing objectives, among other uses.

Benchmarking of asset performance, uptime, costs, KPIs, and any asset metric can be provided by the system through aggregation of data from assets in the EP. Comparable applications, industries, and geographies can be benchmarked and data, reports, and analytics can be presented to a customer. Benchmarking can include repair and maintenance data captured in the system, including asset details, manufacturers, component parts, groups of assets, regions within a company, industry benchmarking, environmental effects, and additional benchmarking criteria the database will facilitate.

Communications: The EP can include an integrated communications platform that connects all stakeholders. It is intended that communications can include PDFs, photos, comments, etc., and each interaction has a unique identifier and is time stamped.

Through use of the EP and integrated communications app, the latitude/longitude location of the remote asset can be captured by the system for geolocation and identification for dispatch of nearest affiliated MRO to repair the asset, including threaded communications relating to the repair request, a defined multi stage notification protocol, automated next day incident reporting and the like.

A client app can be integrated with the EP and used as a communications tool for client access. The data collected from the app while communicating through the EP can provide a constant flow of real-time information that acts as an indicator of service performance of the remote assets. This real-time view can allow fleets to be proactive when service is not to the level expected and provide the data sets to isolate problems and formulate sustainable corrective actions.

In the EP, there may be various procedures available. As an example, a Service Request corresponds to specific service offerings that are available through a Service Type (example may include an emergency repair, invoice question, delivery status or parts inquiry). The relationship between these 3 tiers can be called a “Service Hierarchy” in the communications app. A user creates a Service Request which can either be worked on between customer and service provider, or via a collaborative team environment. The Service Request can then be tracked and monitored while being worked on. Timestamps can be added and the various life cycle statuses can also be measured with a pre-determined schedule to complete.

Using the EP, users and asset owner/operators can take baseline photos of assets anywhere and at any time. A photo is captured and maintained in the asset photo database stored and sorted by unit number and picture date.

Using the EP, MROs, Vendors, and asset owner/operators can utilize the integrated communications app to request emergency assistance, including roadside, at a remote location of the asset. The system can integrate the user's lat/long from their client app into the EP, and the EP can auto-dispatch the service request to the nearest MRO electronically. The integration of the asset specification details with the user location and service request, along with the parts required to complete the repair, dispatch of the MRO, are tasks that can be centrally managed by the EP. The EP gathers the repair data, transaction timestamps for events during the emergency request and can automatically report the details and timestamps of the events. The EP can provide payment to the MRO based on the rules of the customer.

As an example, emergency breakdowns (on road, in remote yards, or the like) can be managed by the system. Telematics or a client app can electronically request emergency assistance via the EP. When the service request is initiated, the system obtains the latitude/longitude of the remote asset and the system/EP can match the latitude/longitude of the nearest service provider that can provide the requested maintenance for the service requested. The EP routes a service request through the communications app to the local affiliated MRO who receives the location of the user/driver, the service requested, claims the repair request back through the app to the EP, and travels to the location of the user/driver to complete the repair. The EP will utilize its maintenance database to determine the parts to be used in the repair and advise the MRO through the communications app so the MRO takes the correct part to the repair site. The MRO follows a scripted method of updating the fleet/customer of the status of the repair using the standard communication app for emergency service request procedures. The time of each stage of the on road breakdown can be electronically captured by the app. The MRO technician and the Fleet/Customer and user/driver can be updated throughout the service call event through the communications app. The customer managing the assets can receive an automated report with all the details including event timing and details of on road repairs. The timing of the repairs can be compared to pre-established or historical KPIs for repairs for determination if on road response time objectives/KPIs were achieved.

Through integration, the EP can be configured to automatically assign the appropriate MRO to a Service Request for emergency assistance, wherever the user/driver is located. When a driver creates an emergency request, a GPS fix of the driver's current location can be included in the request. When the task is received by the system, the GPS location will be inspected and used to find the closest affiliate MRO capable of performing the repair. The task will be routed directly to that MRO or to a group of local MROs. The automated dispatch to nearby vendors reduces the time it takes for an MRO to attend to the driver, reducing downtime and improving fleet efficiency. MROs benefit by having access to repairs they would have otherwise likely not have been requested to receive.

Using the client app or an EP connection, asset owner/operators are able to request service or maintenance for their assets to MROs. The asset owner/operator identifies the type of service requested through the app (urgent, scheduled, unscheduled, emergency, on road breakdown, etc.), thus prioritizing communications with the MROs. The EP can provide asset details with the service repair request, such as unit number/vin lookup, service request date and time, response date and time, and completion date and time.

In some embodiments, if a service request category is flagged by the EP to integrate, then data collected during the service request can be configured to export into other maintenance and business systems. Data such as geo location, asset information, repair request, request date and time, response date and time, completion date and time, and messages etc. can then be imported into other business systems, not limited to maintenance software, telematics systems, and other business systems.

In addition to improving maintenance communications and processes to improve asset uptime and maintenance management efficiency, the client/communications app can store data, images, attachments and messages associated with the Service Request in one location for easy access by reference, including threaded communications. The app may allow for users to rate each Service Request to evaluate service performance independently.

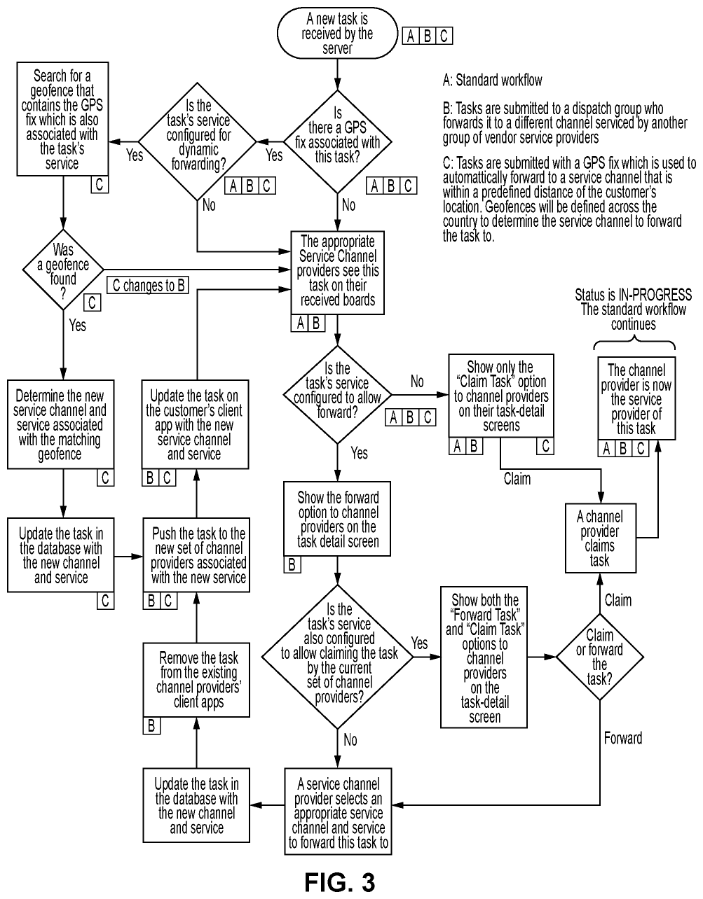

FIG. 3 is a flowchart showing an example of the handling of a task within an embodiment of the system or method herein. In particular, FIG. 3 illustrates how a task may be claimed by a channel provider (for example, an MRO). The handling/processing of the task may include, for example, a determination of whether or not there is a GPS fix associated with the task, whether or not a geofence is available, checking on appropriate providers and whether or not a particular provider can claim a task, where appropriate allowing a provider to claim a task, handling of forwarding the task to appropriate providers, and the like.

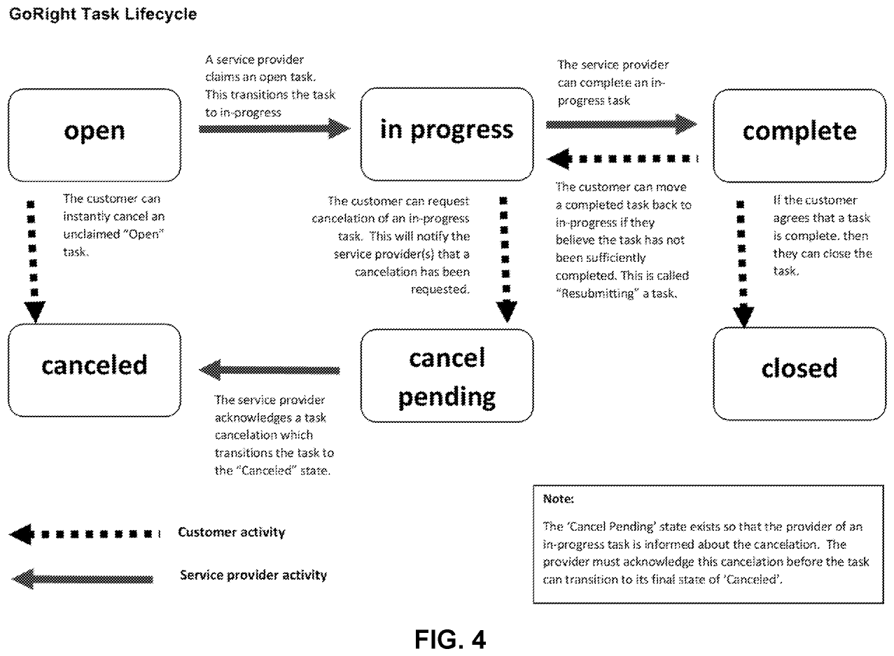

FIG. 4 shows a schematic of an embodiment of an MRO, or the like, claiming a particular task within the system. A task is opened in the system by a submitter, can be automatically claimed by a provider, and then operated on by either the submitter or provider depending on the task. Tasks may be preconfigured or developed for a new task at the time. In some cases, artificial intelligence or machine learning may be used to facilitate a task or the like.

Embodiments of the system and method herein are configured such that, for a task generated within the system, there are detailed processes available in databases and that will be provided together with the task, once generated. The detailed processes may include a requirement to enter data into the system as the task progresses and/or is completed. As one basic example, once a task is claimed, the provider completing the task may be required to enter time based characteristics (for example, the time of arrival/start of the task, any delays in completing the task and a time at which the task is completed) and other types of characteristics related to the task, such as type of service, parts inspected, parts replaced, serial numbers of parts, and others.

In many cases, the process for each task will be configured to move from a high level flow to detailed procedures in a hierarchical fashion. For example, a shop process might include the following steps:

### End to End Shop Process Flow Chart

### 12.00 End to End Shop Process

Shop Process Ch.02 Step 3 references 17.17 Special Order Parts
Shop Process Ch.07 step 1 references Repair Standards
   Repair Standard eg. attached—PM Inspection
   Repair Standard eg. attached—PM Inspection Checklist
   Repair Standard eg. attached—Replace Wheel Seal—step 2 references sign-off sheet
      Replace Wheel Seal step 2 references Wheel End Sign Off Sheet
Shop Process Ch.07 step 2 references Shop Workflow Fishbone
Shop Process Ch.08 step 6 references Customer Invoicing Requirements

As another example, a maintenance component warranty process might include:

### Maintenance Component Warranty Process Flow Chart

### 19.102 Maintenance Component Warranty

Warranty Process Ch. 2.2 step 2 references 19.108 Handheld Screenshots
Warranty Process Ch. 5.1 step 3 references 19.110 Reimburse Sale

Procedure
Warranty Process Ch. 5.3 step 3 references 19.22 WNC Claim Cheque Audit

Form

In these detailed processes and data entry screens, the system can flag when further action may be or is required and/or automatically generate further processes based on the data submitted.

The detailed processes and data entry screens are generally intended to include items such as: step-by-step procedures; critical related info within the process; references; pictures; documents needed; policies; targets and the like.

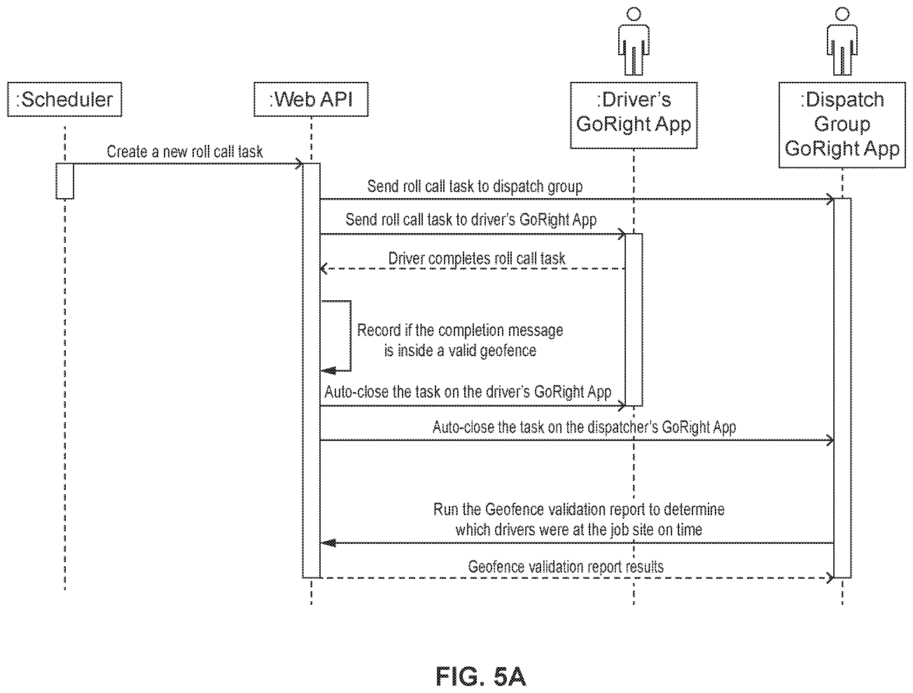

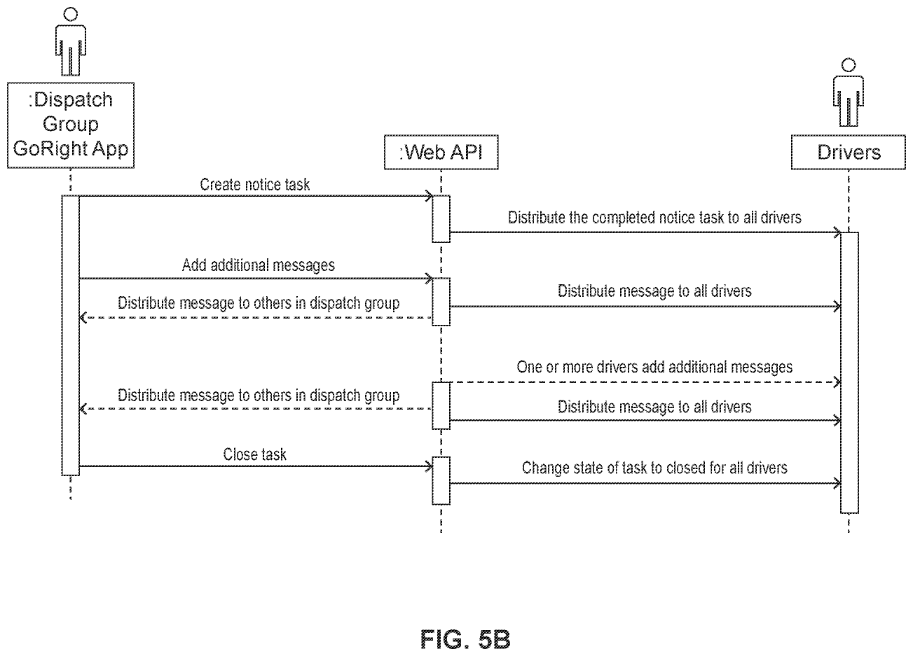

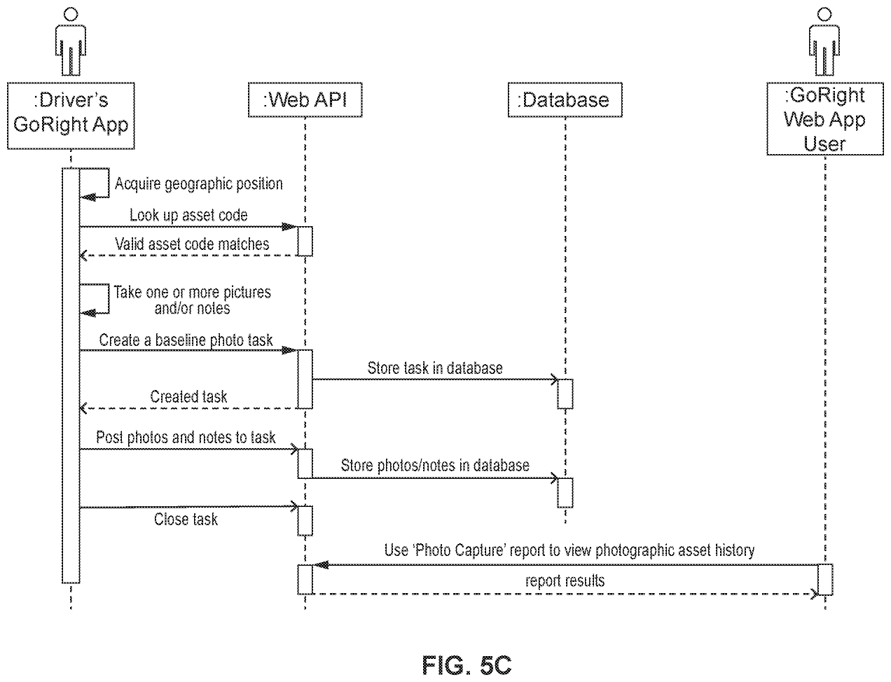

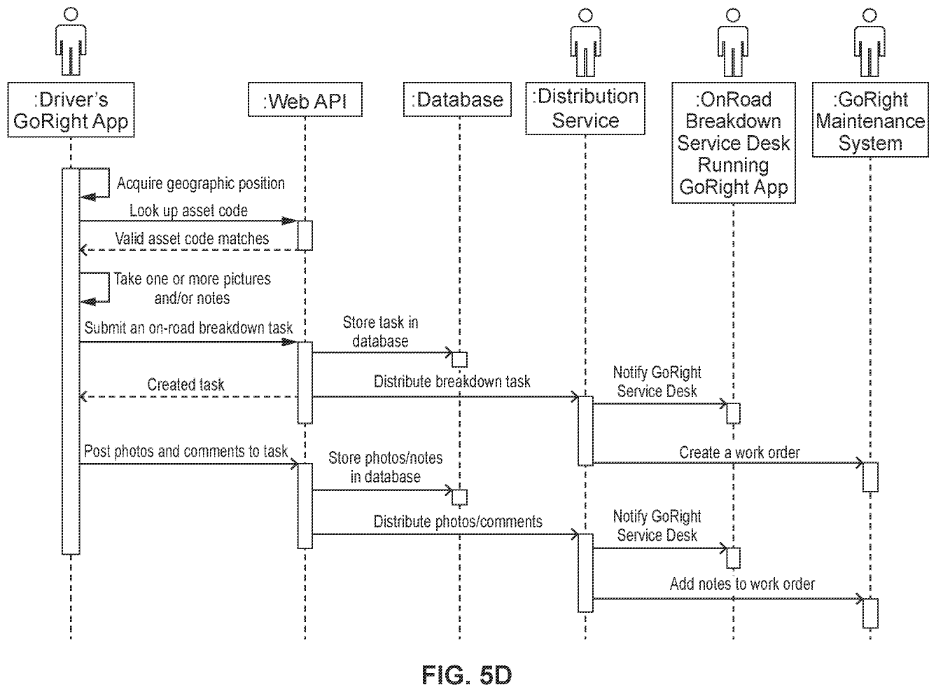

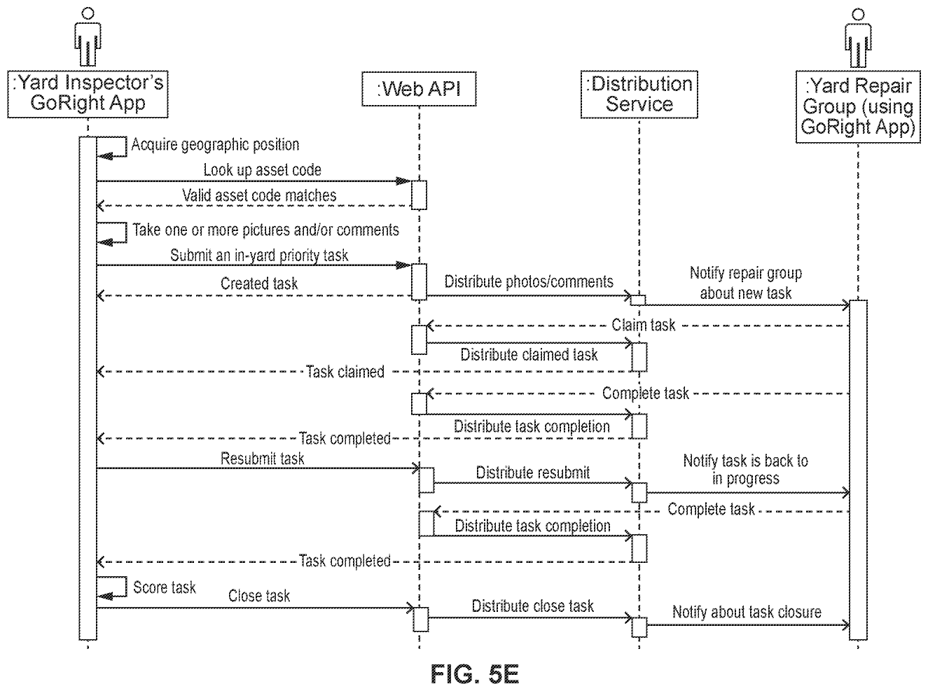

FIG. 5A-5E are schematic drawings illustrating various use case of different kinds of tasks/procedures that may be performed within embodiments of the system and method herein. FIGS. 5A-5E also illustrate modules of the system that may execute the various functions and the processes/methods involved. The system may include one or more processors, memory elements and databased that execute instructions from a computer-readable medium to perform the functions described.

FIG. 5A is a schematic illustrating an embodiment of a process performed by an application and end users for a driver roll call use case.

FIG. 5B is a schematic illustrating an embodiment of a process performed by the application, databases and end users for an information distribution use case.

FIG. 5C is a schematic illustrating an embodiment of a process performed by the application, databases and end users for a historical documentation and pre/post trip inspection (photo capture) use case. This process allows for verification of condition prior to or post trip for safety or other purposes.

FIG. 5D is a schematic illustrating an embodiment of a process performed by the application, databases and end users for an on-road breakdown use case. In this use case, photos may be provided for additional information to be included with a work order.

FIG. 5E is a schematic illustrating an embodiment of a process performed by the application, databases and end users for an urgent service request use case. Note that the task may be assigned a score prior to close for future use in evaluating the process, the person completing the process, or the like.

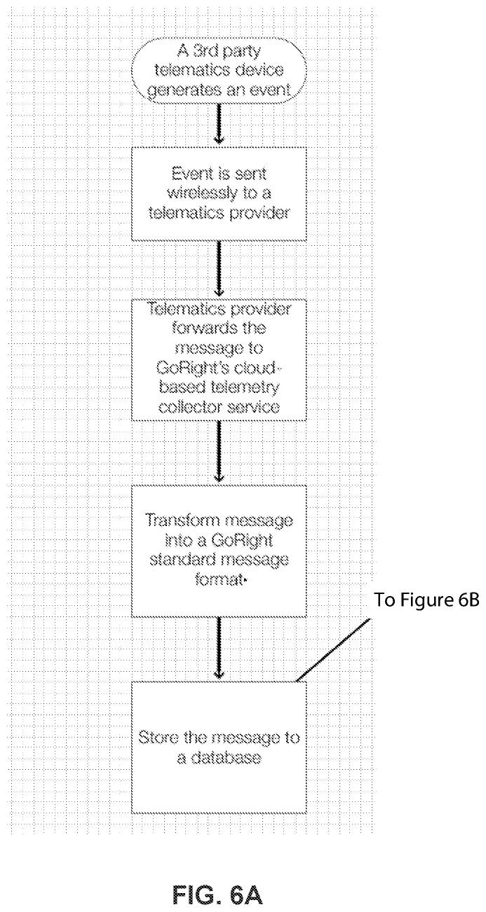

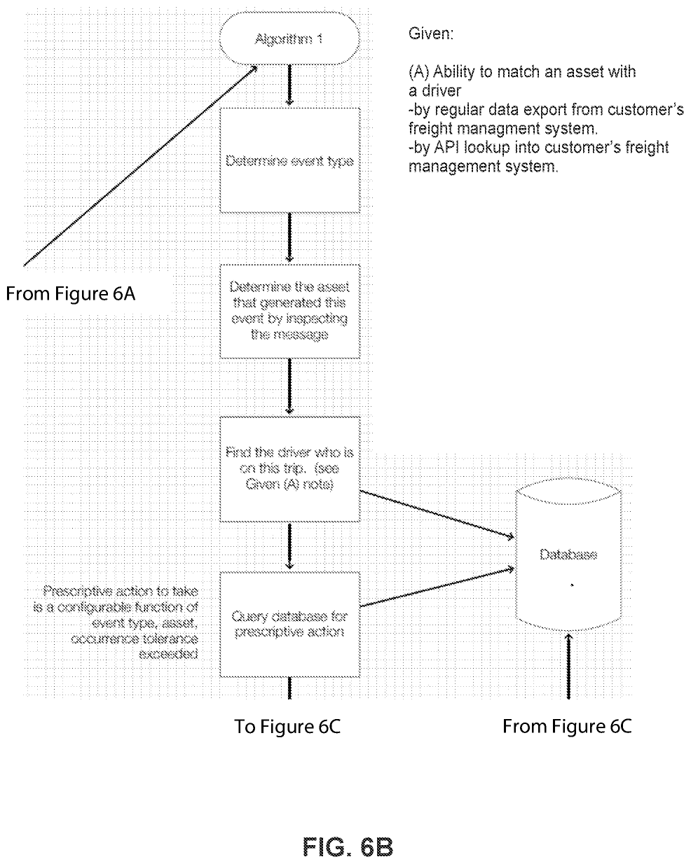

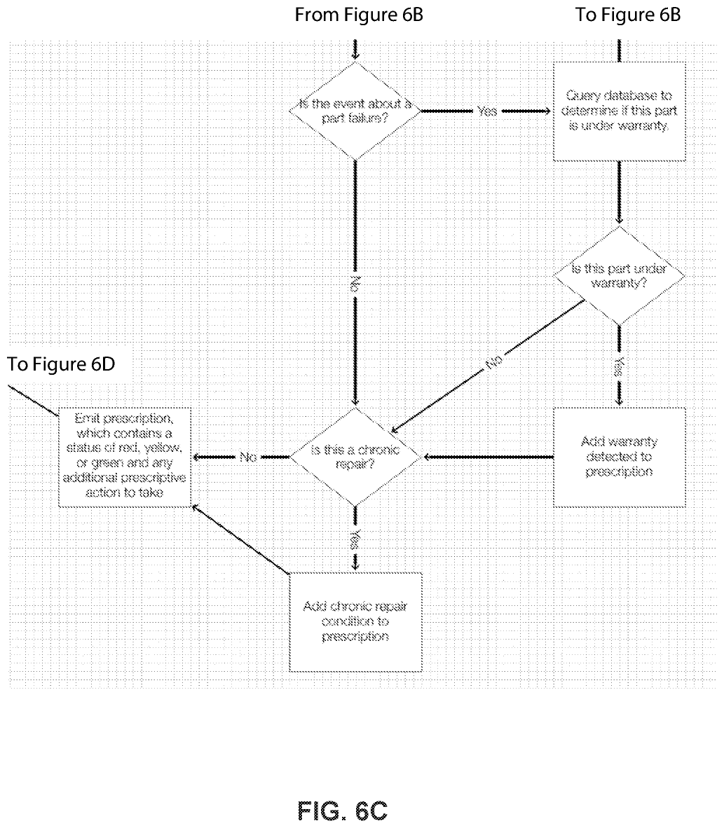

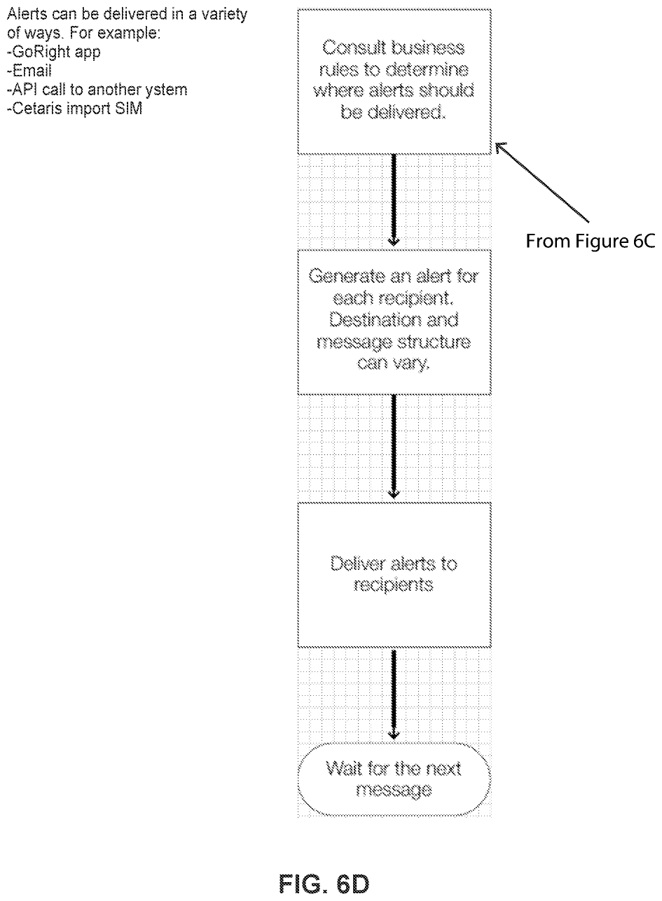

FIGS. 6A-6D show a flowchart illustrating an example of the handling of data and analysis in an embodiment of the system and method for managing remote assets. FIG. 6A shows the receipt and processing of data from a telematics device or the like. In particular, a telematics device will send data via a wireless message to a telematics vendor service, the data will then be forward to a Telematics Integration Module (TIM) in the system. The TIM will transform the data into a standard data format for use by the system. FIGS. 6B and 6C show an example of processing/analysis of data by embodiments of the system herein. In particular, a prescriptive action or actions can be determined that will be used by the system to automatically take action to resolve or help resolve any issues. The prescriptive action will generally be a configurable function of event/issue type, asset, company, driver, meter readings, count of events over a time frame, occurrence tolerance, and the like. FIG. 6D shows the processing of alerts, which may include or be related to the prescriptive action(s), based on the processing/analysis of the data. The prescriptive action(s) may be determined by applying customizable weights to the inputs and the weights may be adjusted over time based on results, other data, or the like. It is noted that the prescriptive actions could vary from fleet/customer to fleet/customer.

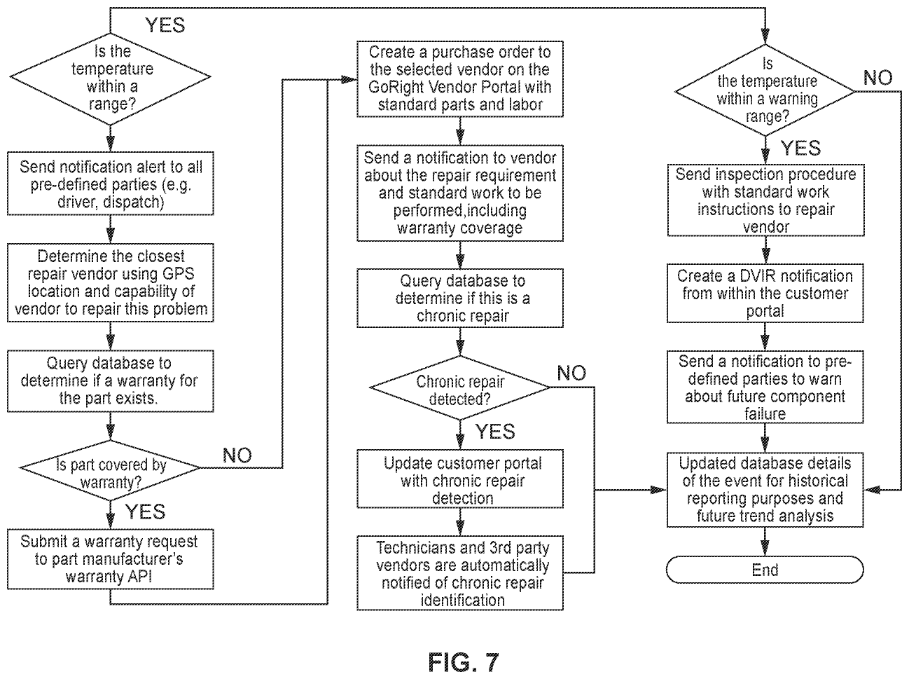

FIG. 7 is a flowchart illustrating an example of a determination of a prescriptive action from the flowchart of FIG. 6. FIG. 7 relates to a particular example in which a telematics wheel end sensor for a trailer has sent data related to a wheel end temperature in the manner illustrated in FIG. 6A. In order to determine a prescribed action, the following process can be followed. The data can be compared with a table of temperature values and tolerances for various components on remote assets to provide an indication of whether or not the data may involve an issue that requires prescribed action and, if so, what prescribed actions should be taken.

In the case of wheel end temperatures, the system may prescribe a critical (Red) approach, a warning (Yellow) approach, or a proceed (Green) approach.

(A) Red (Critical) Condition—wheel end temperature is outside of a range/exceeds a tolerance.

In this case, notification, alerts may include: task notification to driver of critical component failure; notification to vendors of repair requirement and standard work to be performed (times, parts, process); message collaboration—notify others designated by fleet based on pre established protocol

Notification will include that wheel end temp exceeds X—Perform A (A=Prescribed Solution). This can involve a query of vendors in repair geographic area with capabilities for procedure A, sending inspection procedure A with standard work instructions, methods, standard repair times, and costs to repair vendor; automatic creation of purchase order to vendor on vendor portal with standard parts and labour; identification of warranty occurs based on codification of repair order; automatic detection of warranty is made visible in customer portal; warranty is identified and repair vendor is automatically advised of warranty.

In some cases, the system can include integration of warranty information with an OEM. In this case, a warranty module may transform the prescribed solution into a format that is readable by the vendors API format and a standard dataset can be sent to the OEM including data such as repair complaint, cause and correction, equipment details, warranty terms, mileage hours, warranty justification including photos of failed component, amount of warranty claim, and the like.

In some cases, the system may also allow for chronic repair detection. In this case, the repair data can be analyzed to identify opportunities for configuration of the codification of chronic repairs criteria based on number of failures/issues in a predetermined time period or the like. Once configured by parameters in a lookup table, chronic repairs can capture codified transactions and occurrence criteria; customers can provide feedback on the parameters and adjust the occurrence criteria over time as required. Automated chronic repair detections can be identified and are updated in the customer portal and technicians and 3rd party vendors can be automatically notified of chronic repair identification.

After action, a maintenance database can be updated for further prescriptive analytics and equipment design.

(B) Yellow (Inspection Required)—when the data is within specification but near to a threshold.

In this case, the wheel end temperature may exceed a threshold Y—Perform B prescribed action. In particular, B prescribed action may involve sending inspection procedure A with standard work instructions to a repair vendor. Since the condition does not exceed critical tolerance (as in Red above), but is in range where the algorithm flags the condition, the system can automate the creation of a future maintenance requirement and create notification of the condition within the customer portal. In this case, notification, alerts can include a task notification to driver of warning of future component failure and message collaboration to notify others designated on a pre established protocol. It will be understood that warranty and chronic repair detection can be conducted for this type of issue as well.

(C) Green (data capture) is when the data is within tolerance or within a further predetermined threshold. In this case, the database can be updated with the data for historical reporting purposes and future trend analysis.

Another example of using telematics information to determine a prescribed action involves the charging of a liftgate battery for a trailer. In this case, battery type and identifier can be stored for each tractor, refrigeration unit and liftgate and updated as any battery is repaired or replaced. When in operation, the sensor/telematics data related to the batteries are received and stored in the database.

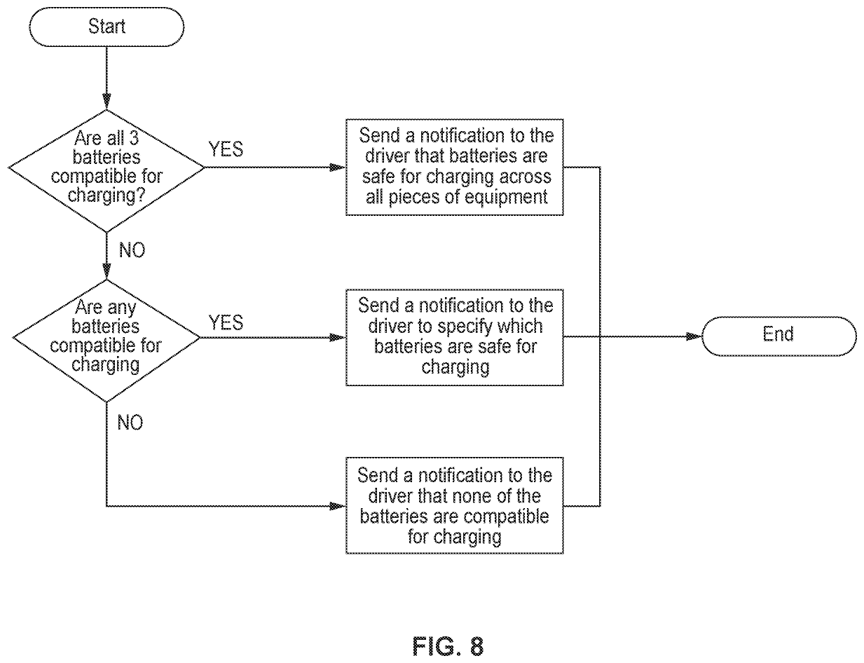

FIG. 8 is an example flow chart of the determination of prescribed actions. Initially, the system can review received data to determine if a battery needs to be charged and then use received data and stored data to determine if the tractor, trailer and liftgate battery configuration match types for compatible charging scenarios. In the particular case of a refrigeration unit and liftgate example, the system can identify the refrigeration unit as having standard lead acid batteries and the liftgate as having AGM batteries such that there is a mismatch. This can be important as the lead acid batteries should not be used to recharge the AGM batteries.

In this situation, notification, alerts can be used to notify the driver of the need to charge the liftgate battery but that there are mismatched batteries so the driver must charge liftgate batteries from an alternate source (such as the tractor, if it has compatibility) because the refrigeration unit is not compatible. The system may also automatically create a repair requirement and standard work to be performed (times, parts, process) to install a matching battery on the refrigeration unit when the trailer returns to base and/or the next preventative maintenance, or the like. As such, the system can act to help prevent charging compatibility issues that tend to cause a large percentage of liftgate battery issues.

Another example of using telematics information to determine a prescribed action relates to wear on tires, which is typically measured by tread depth. In this case, tread depth can be measured during preventative maintenance, annual inspections and the like, and entered into the system. When in operation, the system may track the tread depth by using a burn rate calculation that estimates the burn rate based on various inputs such as distance travelled, environment, tire position, other tire tread depth, historical data based on actual readings, or the like.

The system can then use the estimated tread depth and/or telematics data (such as a loss/reduction in tire pressure or the like, e.g. blown or punctured tire) in order to determine any prescribed actions, which may include, for example, tire replacement or tire rotation.

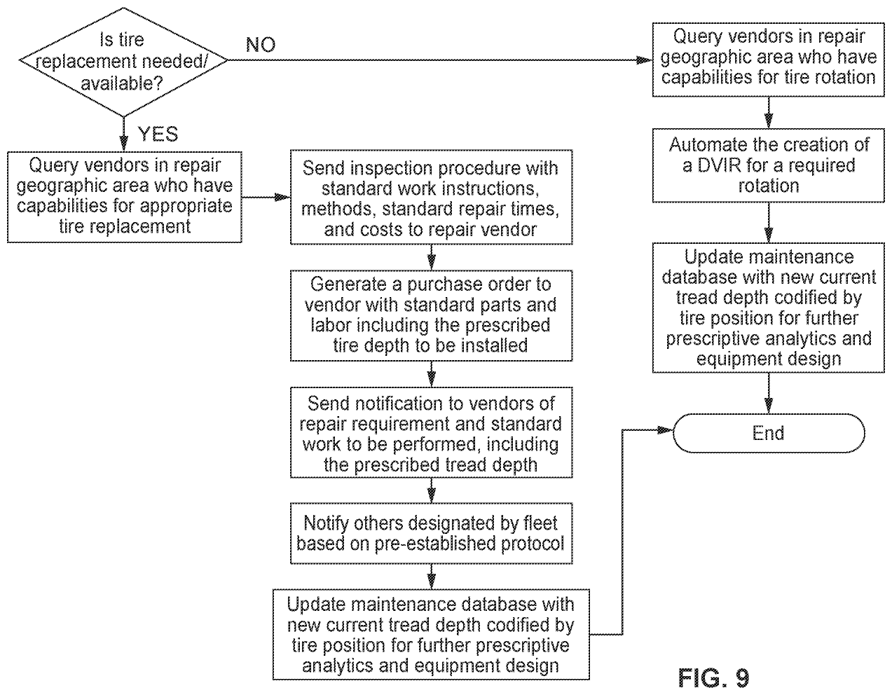

FIG. 9 is a flowchart of an example of a tire replacement scenario. Initially, the system may issue notification or alerts to driver confirming or advising the tire component failure. The system gathers data for a service request such as driver, asset number, position (e.g. lat/long), problem, tire position, date, and time, or the like. The system can then determine current tread depths of other tires on same axle by position based on the burn rate calculator. A service vendor in the local geographic area can be searched and can be notified of the repair requirement and standard work to be performed (times, parts, process) including the prescribed tire tread depth to be installed on the road. If the vendor is capable and available, a purchase order can be sent. The system can also notify others designated by fleet based on pre-established protocols.

In a situation where a vendor has a tire with the same or similar tread depth available, the installation of tire with correct tread depth is completed. The maintenance database is updated with new current tread depth codified by tire position for further prescriptive analytics and equipment design. The matching of tread depths is intended to optimize tire life, reduce further blowouts, and improve safety on the road.

In a situation where a tire of similar tread depth is not available after canvasing local vendors (i.e. replacement not available), a vendor can install a tire with a different tread depth (typically larger), the system flags the condition and automates the creation of a maintenance request for a tire rotation to be carried out and creates notifications to relevant stakeholders. The maintenance database is updated with new current tread depth codified by tire position for further prescriptive analytics and equipment design.

It should be noted that somewhat similar processes can be determined for various other issues including, but not limited to tractor battery voltage outside tolerance, brake lining below allowable measurement, and the like.

Embodiments of the system and method herein are intended to integrate with maintenance and repair organizations (“MROs”) and vendors to facilitate a standardized method and process of repairs, including emergency on road repairs, scheduled and unscheduled maintenance, preventive maintenance and inspections, standardization of parts, standardization of repair methods used to complete repairs, electronic data capture at source of repair, warranty and chronic repair detection at time of repair and/or request for PO, codified repairs to an industry standard convention, among other issues. This is achieved, at least in part, via electronic integrations with MROs.

Embodiments of the system and method herein ae intended to provide data for comparison and benchmarking, including intercompany or intracompany asset benchmarking, which can facilitate analysis, reporting, budgeting, forecasting and the like. Embodiments herein are also intended to provide for monitoring MROs or the like, for example, to check invoices for compliance to standard repair times, standard repair methods, consistency of invoicing of repairs over time, including comparisons of costs of similar repairs done over time, or by vendor comparison of similar repairs. Monitoring can include checking on timely and consistent invoicing, VMRS codification of parts and labour, over-billing, job stacking, over pricing of parts, slow repair turnaround times resulting in idle equipment, missed warranty capture, missed correction of chronic repairs, and other costs that increase the overall maintenance costs.

In the preceding description, for purposes of explanation, numerous details are set forth in order to provide a thorough understanding of the embodiments. However, it will be apparent to one skilled in the art that these specific details may not be required. In other instances, well-known structures may be shown in block diagram form in order not to obscure the understanding. Further, it will be understood that various elements/aspects of each embodiment described herein may be used with other embodiments as appropriate and that each embodiment may include a sub-set of the elements/aspects described therewith.

Embodiments of the disclosure or elements thereof may be represented as a computer program product stored in a machine-readable medium (also referred to as a computer-readable medium, a processor-readable medium, or a computer usable medium having a computer-readable program code embodied therein). The machine-readable medium can be any suitable tangible, non-transitory medium, including magnetic, optical, or electrical storage medium including a diskette, compact disk read only memory (CD-ROM), memory device (volatile or non-volatile), or similar storage mechanism. The machine-readable medium can contain various sets of instructions, code sequences, configuration information, or other data, which, when executed, cause a processor to perform steps in a method according to an embodiment of the disclosure. Those of ordinary skill in the art will appreciate that other instructions and operations necessary to implement the described implementations can also be stored on the machine-readable medium. The instructions stored on the machine-readable medium can be executed by a processor or other suitable processing device, and can interface with circuitry to perform the described tasks.

The above-described embodiments are intended to be examples only. Alterations, modifications and variations can be effected to the particular embodiments by those of skill in the art without departing from the scope, which is defined solely by the claims appended hereto.

What is claimed is:

1. A system for managing remote assets, the system comprising:
a server running software to manage data and communications;
a database accessible by the server;
a client application provided to one or more clients, in communication with the server;
wherein the server is configured to:
receive communications from the remote asset and receive communications from the client application;
analyze the received communications for data related to the remote asset;
determine if the data indicates an issue in relation to the remote asset;
if so:
determine a prescribed action based on the issue and the data;
automatically determine resources for the prescribed action; and
send communications to at least one of the remote asset and the client application with the prescribed action and determined resources,
if not, continue to receive and analyze the received communications.

2. A system according to claim 1, wherein the analyze the received communications for data related to the remote asset comprises combining communications from the remote asset with communications from the client application and database entries.

3. A system according to claim 1, wherein the determine if the data indicates an issue comprises comparing the data to one or more thresholds.

4. A system according to claim 3, wherein the issue is selected from the group of wheel end temperature overheating, loss of tire pressure, battery mismatch, and battery charge out of range.

5. A system according to claim 1, wherein the determine a prescribed action comprises matching the data and issue with a prescribed action based on at least one of historical data and a predetermined table of prescribed actions.

6. A system according to claim 1, wherein the automatically determine resources comprises:
determining a location of the remote asset;
determining resources that has a location geographically proximate to the remote asset;
contacting the resources to determine availability and select one or more resources based on location and availability; and
confirm the one or more selected resources to provide the prescribed action.

7. A system according to claim 1, wherein the prescribed action comprises one or more of determine a service vendor in the vicinity of the remote asset, notify a driver to stop the remote asset for repair, notify a driver to go to a determined service vendor for repair, flag a remote asset for preventative maintenance at the next available opportunity.

8. A method for managing remote assets, the method comprising computer-executable instructions that when performed on a processor cause the processor to:
receive communications from the remote assets and receive communications from a client application;
analyze the received communications for data related to each remote asset;
determine if the data indicates an issue in relation to the remote asset;
if so:
determine a prescribed action based on the issue and the data;
automatically determine resources for the prescribed action; and
send communications to at least one of the remote asset and the client application with the prescribed action and determined resources,
if not, continue to receive and analyze the received communications.

9. A method according to claim 8, wherein the analyze the received communications for data related to the remote asset comprises combining communications from the remote asset with communications from the client application and database entries.

10. A method according to claim 8, wherein the determine if the data indicates an issue comprises comparing the data to one or more thresholds.

11. A method according to claim 10, wherein the issue is selected from the group of wheel end temperature overheating, loss of tire pressure, battery mismatch, and battery charge out of range.

12. A method according to claim 8, wherein the determine a prescribed action comprises matching the data and issue with a prescribed action based on at least one of historical data and a predetermined table of prescribed actions.

13. A method according to claim 8, wherein the automatically determine resources comprises:
determining a location of the remote asset;
determining resources that has a location geographically proximate to the remote asset;
contacting the resources to determine availability and select one or more resources based on location and availability; and
confirm the one or more selected resources to provide the prescribed action.

14. A method according to claim 8, wherein the prescribed action comprises one or more of determine a service vendor in the vicinity of the remote asset, notify the determined service vendor to attend at the remote asset location, notify a user to stop the remote asset for repair, notify a user of the remote asset to go to a determined service vendor for repair, flag a remote asset for preventative maintenance at the next available opportunity.
